(19) United States
(12) Patent Application Publication
(10) Pub. No.: US 2011/0024521 A1
(43) Pub. Date: Feb. 3, 2011

(54) AROMATIC NEBULIZING DIFFUSER

(76) Inventor: Carsten Jörgensen, Kastanienbaum (CH)

Correspondence Address: SINORICA, LLC, 2275 Research Blvd., Suite 500, ROCKVILLE, MD, 20850, US

(21) Appl. No.: 12/510,400

(22) Filed: Jul. 28, 2009

(51) Int. Cl. B05B 3/04; B05B 17/00

(52) U.S. Cl. 239/102.1; 239/289

(57) ABSTRACT

A high-safety, high-performance aromatic nebulizing diffuser capable of producing sound and lighting effects is disclosed to include a base panel, an electronic control unit, a speaker, an electric fan, a fluid container, an ultrasonic oscillator, a fluid intake control device set in between the oscillation chamber and the fluid container, a dip tube in communication between the oscillation chamber and the fluid container and changeable between an open status and a close status to control the fluid intake control device in closing/opening the passage between the oscillation chamber and the fluid container, an outer housing, a holder defining an oscillation chamber at the top and a cover at the bottom, an air passage in air communication between the oscillation chamber and the cover for the passing of currents of air caused by the electric fan, an exhaust passage for guiding a generated fine mist of aromatic fluid droplets out of the oscillation chamber into the atmosphere.

### BACKGROUND OF THE INVENTION

1. Field of the Invention

The present invention relates to an aromatic nebulizing diffuser and more particularly, to such an easily detachable nebulizing diffuser of high level of safety that provides sound and lighting effects.

2. Description of the Related Art

A known aromatic nebulizing diffuser or essential oil diffuser uses an ultrasonic oscillator to generate a high ultrasonic energy for causing atomization of an essential oil for application. Separation of electric charges in falling rain, caused by breaking up of the water droplets, the drops becoming positively charged and the air negatively charged. This separation of electric charges accompanying the aerodynamic breakup of water drops is known as spray electrification, the waterfall effect or Lenard effect. Conventional aromatic nebulizing diffusers simply produce an upwardly flying mist of aromatic gas. They cannot simulate the natural visual effect of a flying mist caused by the impact of a waterfall.

Further, regular aromatic nebulizing diffusers commonly use screws to affix component parts together, complicating mounting and dismounting procedures. After a long use of a conventional aromatic nebulizing diffuser, the inside wall of the aromatic nebulizing diffuser will be covered with a layer of dirt. It takes much time and labor to practice a cleaning work.

Further, the opening of a regular aromatic nebulizing diffuser has a diameter gradually reducing from the inside toward the outside. This gradually reducing diameter design tends to cause the generated fine mist to be condensed into water drops, lowering the fin mist generating performance.

Further, regular aromatic nebulizing diffusers simply have one single chamber for holding an aromatic fluid for oscillation by an ultrasonic oscillator to generate a fine mist of aromatic fluid droplets. To oscillate a big volume of aromatic fluid or essential oil in a big chamber requires a big capacity of ultrasonic oscillator.

Further, when a thermal type, electronic type or ultrasonic type aromatic diffuser falls to the floor accidentally, the contained essential oil may leak out, causing risks and damages.

### SUMMARY OF THE INVENTION

The present invention has been accomplished under the circumstances in view. It is main object of the present invention to provide an aromatic nebulizing diffuser, which automatically supplies an aromatic fluid to the oscillation chamber thereof for producing a fine mist of aromatic fluid droplets.

It is another object of the present invention to provide an aromatic nebulizing diffuser, which prohibits leakage of the storage aromatic fluid upon accidental falling, avoiding danger.

It is still another object of the present invention to provide an aromatic nebulizing diffuser, which produces sound and lighting effects while generating a fine mist of aromatic fluid droplets.

It is still another object of the present invention to provide an aromatic nebulizing diffuser, which generates a fine mist of aromatic fluid droplets efficiently.

To achieve these and other objects of the present invention, a base panel, an electronic control unit, a speaker, an electric fan, a fluid container, an ultrasonic oscillator, a fluid intake control device set in between the oscillation chamber and the fluid container, a dip tube in communication between the oscillation chamber and the fluid container and changeable between an open status and a close status to control the fluid intake control device in closing/opening the passage between the oscillation chamber and the fluid container, an outer housing, a holder defining an oscillation chamber at the top and a cover at the bottom, an air passage in air communication between the oscillation chamber and the cover for the passing of currents of air caused by the electric fan, an exhaust passage for guiding a generated fin mist of aromatic fluid droplets out of the oscillation chamber into the atmosphere.

Further, the ultrasonic oscillator is mounted in the fluid container at the bottom side and electrically connected to the electronic control unit for oscillating the aromatic fluid in the oscillation chamber to produce a fine mist of aromatic fluid droplets. Further, the outer housing surrounds the fluid container and abutted against the base panel. The outer housing can be transparent or light transmissive, having an opening in communication between the exhaust passage and the atmosphere.

Further, the outer housing and the fluid container or holder are preferably prepared from transparent or translucent materials. A transparent material allows a person to see through. A translucent material allows light to pass through. The outer housing, the fluid container and the holder can be prepared from, for example, light transmissive ceramics, transparent or translucent plastics, glass, acrylic, frosted glass or any other suitable materials having pores.

### BRIEF DESCRIPTION OF THE DRAWINGS

FIG. 1 is an elevational view of an aromatic nebulizing diffuser in accordance with the present invention.

FIG. 2A is an exploded view of the upper part of the aromatic nebulizing diffuser in accordance with the present invention.

FIG. 2B is an exploded view of the lower part of the aromatic nebulizing diffuser in accordance with the present invention.

FIG. 3 is a perspective view in an enlarged scale of the holder shown in FIG. 2B.

FIG. 4 is a longitudinal sectional view of the aromatic nebulizing diffuser in accordance with the present invention.

FIG. 5 is another longitudinal sectional view of the aromatic nebulizing diffuser in accordance with the present invention when viewed from another direction.

FIG. 6 is a sectional elevation of the aromatic nebulizing diffuser in accordance with the present invention.

### DETAILED DESCRIPTION OF THE PREFERRED EMBODIMENT

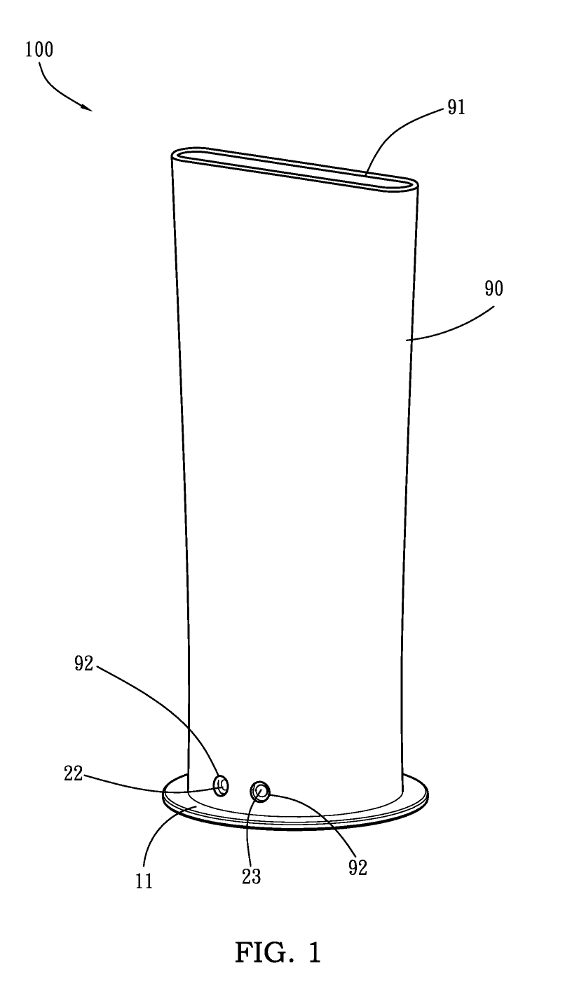

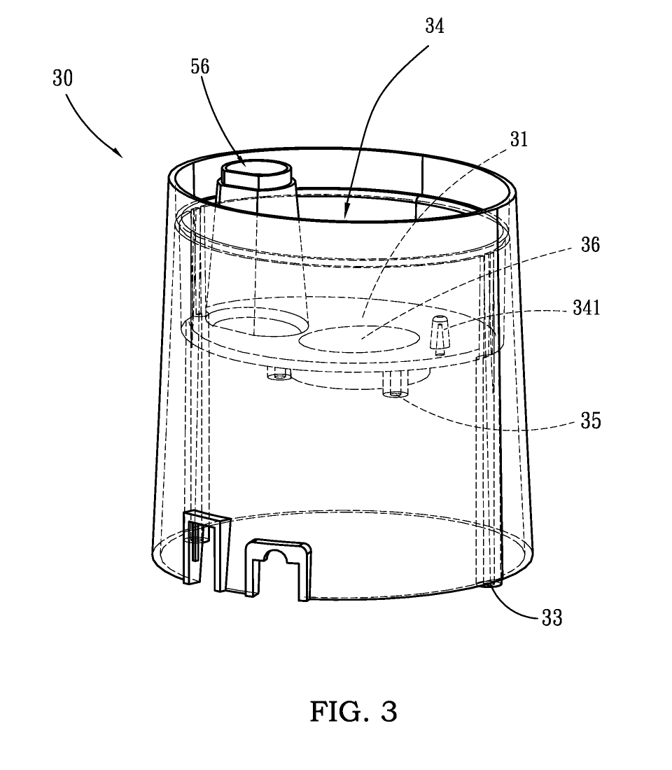

Referring to FIGS. 1, 2A, 2B and 3, an aromatic nebulizing diffuser 100 in accordance with the present invention is shown comprising:

a base panel 10;

an electronic control unit 20 mounted on the base panel 10;

an electric fan 40 mounted on the base panel 10 and electrically connected to the electric control unit 20;

a holder 30, which has a transverse partition board 31 that has a center opening 36 and divides the holder 30 into an upper part that defines an oscillation chamber 34 and a lower part that defines a cover 32, and an air passage 56 formed of an open-ended duct and set in air communication between the space inside the cover 32 and the oscillation chamber 34 to provide a path for delivering air currents caused by the electric fan 40;

a fluid container 50, which is mounted in the holder 30, comprising a container body 51, a container base 52 fastened to the bottom side of the container body 51 and defining with the container body 51 a fluid storage chamber 53 and an exhaust passage 57 in air communication between the oscillation chamber 34 and the atmosphere for exhaust of a mist out of the oscillation chamber 34;

an ultrasonic oscillator 60 mounted in the opening 36 of the holder 30 and electrically connected to the electronic control unit 20 for oscillating an aromatic fluid in the oscillation chamber 34 to produce a fine mist of aromatic fluid droplets;

a fluid intake control device 70 mounted in the bottom side of the fluid container 50 and set between an open status and a close status to control delivery of a fluid from the fluid storage chamber 53 to the oscillation chamber 34;

a dip tube 80 set in the fluid container 50 in communication between the fluid storage chamber 53 and the oscillation chamber 34; and

an outer housing 90 surrounding the fluid container 50 and abutted against the base panel 10 and having an opening 91 in air communication between the exhaust passage 57 and the atmosphere.

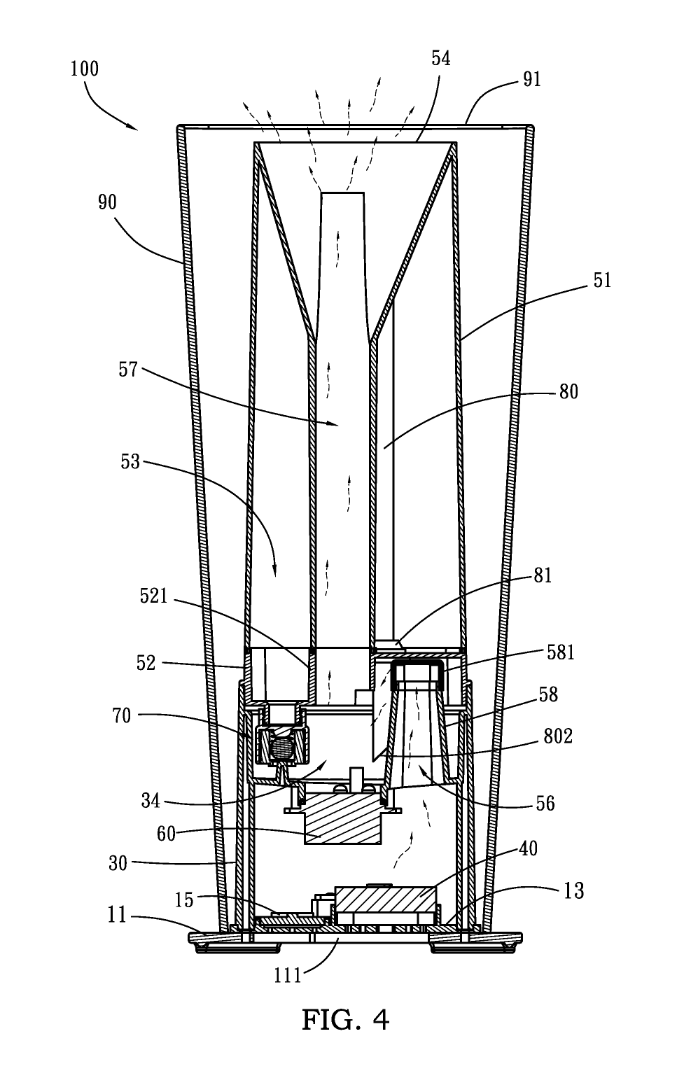

Referring to FIG. 4, subject to the control of the fluid intake control device 70, an aromatic fluid is repeatedly supplied from the fluid container 50 to the oscillation chamber 34 where the ultrasonic oscillator 60 oscillates the aromatic fluid to produce a fine mist of aromatic fluid droplets that is then carried out of the exhaust passage 57 into the atmosphere by currents of air that are caused by the electric fan 40 and flow through the air passage 56 into the oscillation chamber 34.

According to the present preferred embodiment, the opening 91 of the outer housing 90 is a narrow, elongated, rectangular opening located on the top side of the outer housing 90. Further, the container body 51 of the fluid container 50 has a narrow elongated top opening 54. When a fine mist of aromatic fluid droplets is delivered upwardly out of the narrow elongated top opening 54 of the fluid container 50 and the narrow, elongated, rectangular opening 91 of the outer housing 90, a curtain of fine mist of aromatic fluid droplets is seen at the top side of the aromatic nebulizing diffuser 100.

The base panel 10 is comprised of a bottom plate 11 and a bearing plate 13. The bottom plate 11 has an opening 111. The bearing plate 13 has a fan mounting zone 131 and a speaker mounting zone 132 disposed in air communication with the opening 111 to provide a passage for enabling the electric fan 40 to suck in air from the outside and for speaker sound source output.

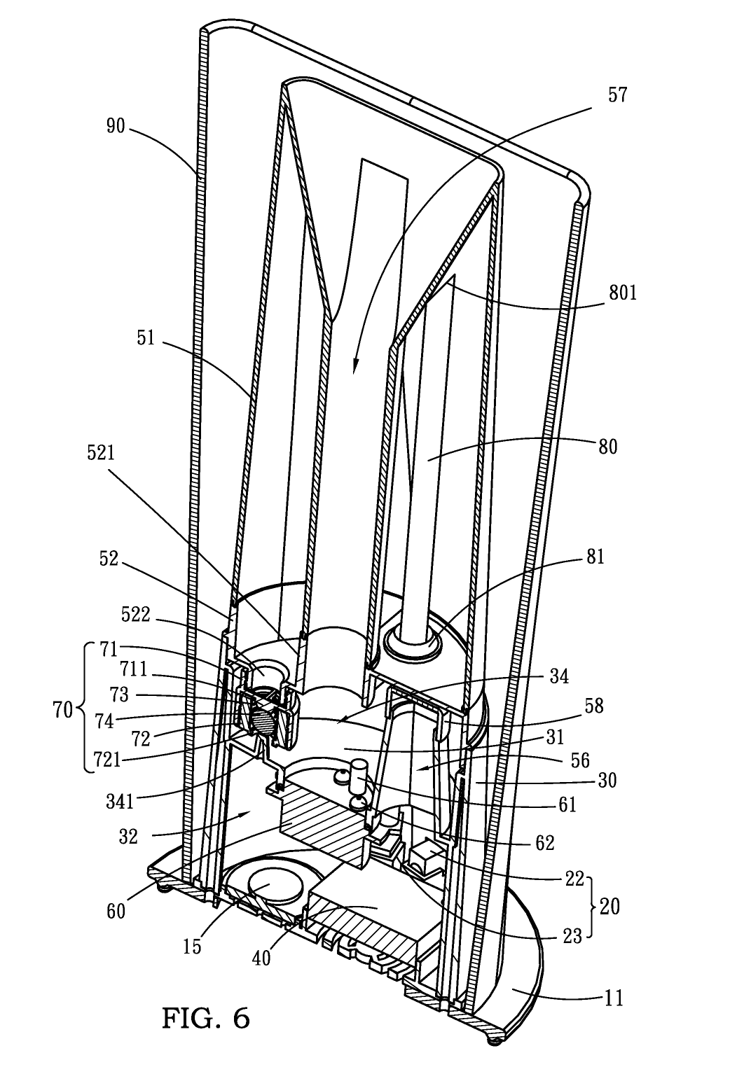

Referring to FIGS. 4-6, the electronic control unit 20 comprises a control circuit board 21, a power jack 22 and a sound-source jack 23. The control circuit board 21 is mounted on the bearing plate 13 of the base panel 10. The power jack 22 is mounted on the bearing plate 13 of the base panel 10 and aimed at a first cable hole 321 that cut through the peripheral wall of the holder 30 at the bottom side for the connection of a power cable (not shown) to provide the necessary working power supply to the control circuit board 21. The sound-source jack 23 is mounted on the bearing plate 13 of the base panel 10 and electrically connected to the control circuit board 21, and aimed at a second cable hole 322 that cut through the peripheral wall of the holder 30 at the bottom side and disposed at one lateral side relative to the first cable hole 321 for the connection of a sound source cable (not shown) to transmit an audio signal from an external sound source to the control circuit board 21.

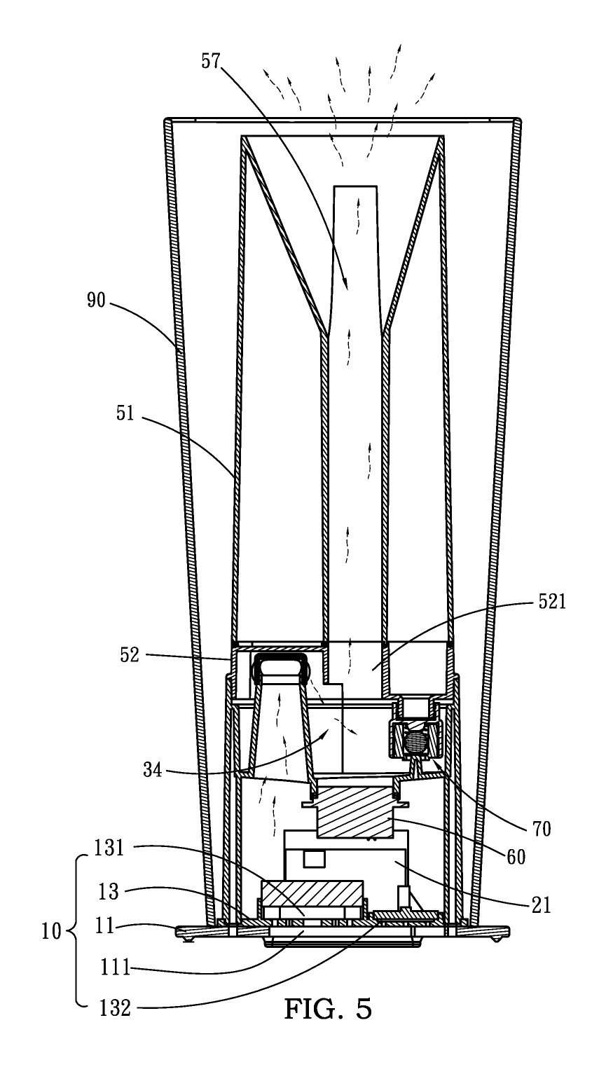

The aforesaid first cable hole 321 and second cable hole 322 are located on the cover 32 of the holder 30. The bearing plate 13 is arranged on the top side of the bottom plate 11 and surrounded by the cover 32 of the holder 30. The holder 30 further has an exhaust fitting 58 mounted on the inside and capped on the top end of the air passage 56. The exhaust fitting 58 has an exhaust port 581 for adjusting air output and diffusion direction (see FIG. 5).

The electric fan 40 is mounted on the fan mounting zone 131 of the bearing plate 13 of the base panel 10 and electrically connected to the control circuit board 21 of the electronic control unit 20 so that the control circuit board 21 controls on/off of the electric fan 40.

The exhaust passage 57 of the fluid container 50 is isolated from the fluid storage chamber 53. The container base 52 of the fluid container 50 has an upwardly extending connection tube 521, which is disposed at a relatively higher elevation, and a downwardly extending fluid intake port 522, which is disposed at a relatively lower elevation for the intake of an aromatic fluid. The upwardly extending connection tube 521 is connected to the exhaust passage 57 of the fluid container 50.

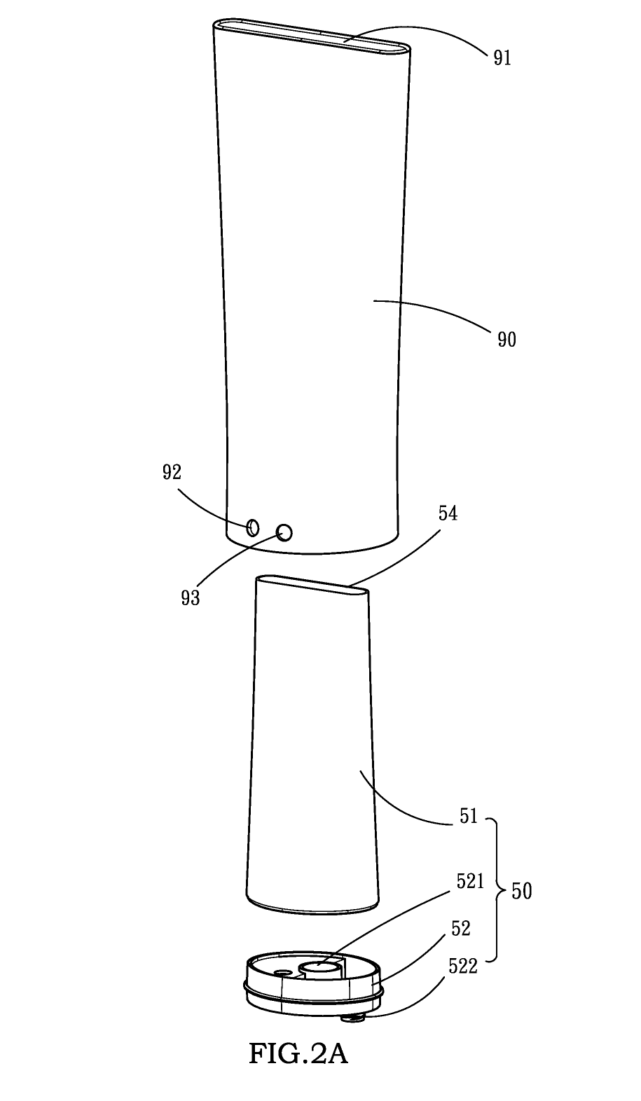

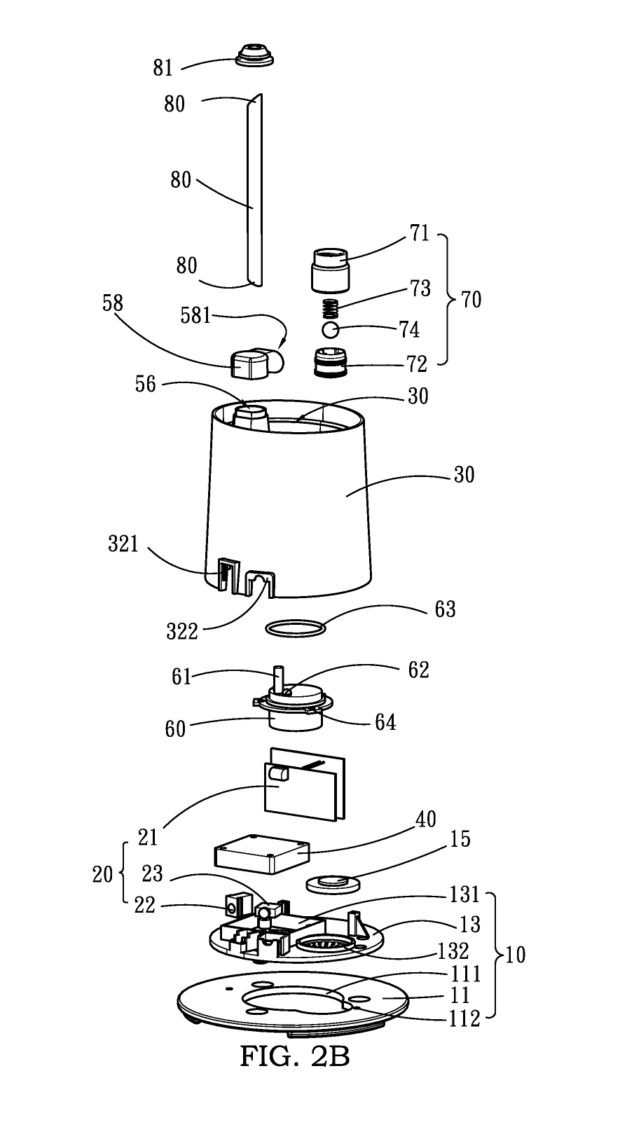

Referring to FIGS. 2A, 2B, 4, 5 and 5, the ultrasonic oscillator 60 is a high frequency oscillator that oscillates hundred thousands to millions times per second. The ultrasonic oscillator 60 is mounted on the transverse partition board 31 of the holder 30 above the center opening 36 and electrically connected to the control circuit board 21, having a water level sensor 61 and at least one light emitting device 62 provided at the top side thereof. The water level sensor 61 and the light emitting device 62 are disposed in the oscillation chamber 34. The light emitting device 62 emits light rays that penetrate through the fine mist or aromatic fluid in the oscillation chamber 34, the container body 51 and the outer housing 90. Switch means (not shown) is provided inside the ultrasonic oscillator 60, and controllable by the water level sensor 61 to turn on/off the ultrasonic oscillator 60 and/or the light emitting device 62. A water seal ring 63 is packed in between the periphery of the ultrasonic oscillator 60 and the periphery of the center opening 36 of the transverse partition board 31 of the holder 30, preventing leakage from the oscillation chamber 34.

The fluid intake control device 70 comprises a first casing 71, a second casing 72, a spring member 73 and a ball 74. The first casing 71 is connected to the downwardly extending fluid intake port 522 of the container base 52 of the fluid container 50 by a screw joint. The second casing 72 is fastened to the bottom side of the first casing 71 in such a manner that the first casing 71 and the second casing 72 define a passage in fluid communication between the oscillation chamber 34 and the fluid storage chamber 53. Further, the first casing 71 has an inside annular flange 711 disposed in the passage in proximity to the fluid storage chamber 53. The second casing 72 has a ball hole 721 disposed in the passage in proximity to the oscillation chamber 34. The spring member 73 is mounted in the passage inside the first casing 71 and the second casing 72, and stopped with its one end against the bottom side of the inside annular flange 711. The ball 74 according to the present preferred embodiment is a steel ball held down on the ball hole 721 by the spring member 73 to stop the passage, preventing leakage of a fluid out of the fluid storage chamber 53 through the downwardly extending fluid intake port 522.

The holder 30 further has a protruding portion 341 upwardly extended from the transverse partition board 31 and suspending in the oscillation chamber 34 for insertion into the ball hole 721 of the second casing 72 of the fluid intake control device 70 to move the ball 74 upwardly away from the ball hole 721 and to further open the passage between the fluid storage chamber 53 and the oscillation chamber 34 for enabling a fluid to flow from the fluid storage chamber 53 into the oscillation chamber 34. On the contrary, when moved the protruding portion 341 away from the ball hole 721 of the second casing 72 of the fluid intake control device 70, the spring member 73 immediately forces the ball 74 to stop the ball hole 721, prohibiting flowing of the storage fluid out of the fluid storage chamber 53.

The dip tube 80 has a top open end 801 and a bottom open end 802. Further, the dip tube 80 is inserted into the fluid storage chamber 53 of the fluid container 50 and the oscillation chamber 34 and secured in place by a gasket ring 81, keeping the top open end 801 above the elevation of the fluid level in the fluid storage chamber 53 and the bottom open end 802 in contact with the fluid level in the oscillation chamber 34. In coordination with connection of the fluid intake control device 70 to the downwardly extending fluid intake port 522 of the container base 52 of the fluid container 50, the protruding portion 341 of the holder 30 is inserted into the ball hole 721 of the second casing 72 of the fluid intake control device 70 to move the ball 74 upwardly away from the ball hole 721 and to further open the passage between the fluid storage chamber 53 and the oscillation chamber 34. At this time, the inside pressure of the fluid storage chamber 53 and the inside pressure of the oscillation chamber 34 are in balance, so that the storage aromatic fluid flows, subject to a hydraulic head difference, in proper order from the fluid storage chamber 53 through the downwardly extending fluid intake port 522 of the container base 52 of the fluid container 50 and the fluid intake control device 70 into the oscillation chamber 34. When the fluid level in the oscillation chamber 34 reaches a predetermined elevation to block the bottom open end 802 of the dip tube 80, filling of the aromatic fluid into the oscillation chamber 34 is stopped. On the contrary, when the fluid level is lowered to an elevation without blocking the bottom open end 802 of the dip tube 80, the dip tube 80 is returned to the status in air communication between the fluid storage chamber 53 and the inside pressure of the oscillation chamber 34 for enabling the aromatic fluid to flow from the fluid storage chamber 53 and the inside pressure of the oscillation chamber 34 again subject to the effect of a hydraulic head difference. This action is repeated again and again to supply the aromatic fluid to flow from the fluid storage chamber 53 and the inside pressure of the oscillation chamber 34 continuously. Therefore, the invention eliminates the drawback of the prior art design that cannot refurnish an aromatic fluid automatically.

Further, if the aromatic nebulizing diffuser 100 falls to the ground accidentally, one of the top open end 801 and bottom open end 802 of the dip tube 80 will be blocked by the aromatic fluid and/or the fluid intake control device 70 that is connected to the fluid container 50 will not be induced by the gravity and a hydraulic head difference to let the storage aromatic fluid leak out of the fluid container 50, assuring a high level of safety.

The invention uses the fluid container 50 to store an aromatic fluid and the oscillation chamber 34 to hold a relatively smaller volume of the aromatic fluid for producing a fine mist of aromatic fluid droplets. Because the volume of the oscillation chamber 34 is much smaller than the volume of the fluid container 50, oscillation of the ultrasonic oscillator 60 in the oscillation chamber 34 can cause a fin mist of aromatic fluid more quickly than the formation of a fine mist of aromatic fluid droplets by means of oscillating a same capacity of ultrasonic oscillator in the fluid container 50. When compared to the prior art design that uses a single large storage chamber for generating a fine mist of aromatic fluid droplets, the invention shows a better performance. Further, the volume of the oscillation chamber 34 must be smaller than that of the fluid storage chamber 53 of the fluid container 50.

Referring to FIG. 1, the outer housing 90 surrounds the fluid container 50 and abutted against the bottom plate 11 of the base panel 10. Further, the outer housing 90 has two through holes 92 and 93 respectively disposed in communication with the first cable hole 321 and second cable hole 322 of the cover 32 of the holder 30.

Referring to FIGS. 2B, 4 and 5, the speaker 15 is mounted on the speaker mounting zone 132 of the bearing plate 13 of the base panel 10 and electrically connected to the control circuit board 21 of the electronic control unit 20 such that the control circuit board 21 control the speaker 15 to output the audio signal that is received by the control circuit board 21 from an external sound source through the sound-source jack 23.

Referring to FIGS. 2B, 3 and 4, the transverse partition board 31 of the holder 30 has a plurality of mounting holes 35 and columns 33. The ultrasonic oscillator 60 has a plurality of mounting holes 64 arranged around the border and respectively fastened to the mounting holes 35 by screws (not shown). The bottom plate 11 of the base panel 10 further has a plurality of mounting holes 112 respectively fastened to the columns 33 of the transverse partition board 31 of the holder 30 by screws (not shown).

After understanding of the composition of the aromatic nebulizing diffuser 100, the operation of the aromatic nebulizing diffuser 100 is outlined hereinafter.

Referring to FIGS. 1˜6, at first, the user pours the prepared aromatic fluid (for example, a mixture of an essential oil and water) into the fluid storage chamber 53 of the fluid container 50. At this time, the protruding portion 341 of the holder 30 is inserted into the ball hole 721 of the second casing 72 of the fluid intake control device 70 to move the ball 74 upwardly away from the ball hole 721 and to further open the passage between the fluid storage chamber 53 and the oscillation chamber 34. Thus, the aromatic fluid flows from the fluid storage chamber 53 into the oscillation chamber 34. Thus, the user can control the ultrasonic oscillator 60 to oscillate and to cause a fine mist of aromatic fluid droplets to be produced in the oscillation chamber 34. At the same time, the electric fan 40 is started up to suck in currents of air from the atmosphere through the bottom plate 11, the air passage 56 and the exhaust port 581 into the oscillation chamber 34, enabling the currents of air to carry the produced fine mist of aromatic fluid droplets out of the oscillation chamber 34 through the exhaust passage 57, the narrow elongated top opening 54 of the fluid container 50 and the narrow rectangular opening 91 of the outer housing 90 to the atmosphere.

Further, the top opening 54 of the fluid container 50 and the opening 91 of the outer housing 90 are narrow, elongated, rectangular openings gradually increasing in width from the inside of the aromatic nebulizing diffuser 100 toward the outside, molecules of the fine mist of aromatic fluid droplets will not be compressed into drops of fluid and will be quickly scattered in the outside air.

Further, the sound-source jack 23 allows input of a sound source signal from any of a variety of music players for output through the speaker 15 to add a sound effect to the visual effect of the floating of the fine mist of aromatic fluid droplets.

Further, when the level of the aromatic fluid in the oscillation chamber 34 drops below a predetermined low level, the fluid level sensor 61 of the ultrasonic oscillator 60 immediately outputs a signal to turn off the ultrasonic oscillator 60, avoiding damage.

Further, the outer housing 90, the fluid container 50 and the holder 30 are transparent or light transmissive. Each light emitting device 62 of the ultrasonic oscillator 60 can be a light emitting diode of a predetermined color. During operation of the ultrasonic oscillator 60, the at least one light emitting device 62 emits color light rays through the outer housing 90, the fluid container 50 and the holder 30, producing a lighting effect.

Further, the aromatic nebulizing diffuser 100 is easy to assemble and disassemble, facilitating cleaning and maintenance.

A prototype of aromatic nebulizing diffuser has been constructed with the features of FIGS. 1˜5. The aromatic nebulizing diffuser functions smoothly to provide all of the features disclosed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. An aromatic nebulizing diffuser, comprising:
a base panel;
an electronic control unit mounted on said base panel;
an electric fan mounted on said base panel and electrically connected to and controllable by said electric control unit;
a holder, which has a transverse partition board that has a center opening and divides said holder into an upper part that defines an oscillation chamber and a lower part that defines a cover, and an air passage set in air communication between the space inside said cover and said oscillation chamber to provide a path for delivering air currents caused by said electric fan;
a fluid container, which is mounted in said holder, comprising a container body, a container base fastened to a bottom side of said container body and defining with said container body a fluid storage chamber and an exhaust passage in air communication between said oscillation chamber and the atmosphere for exhaust of a mist out of said oscillation chamber;
an ultrasonic oscillator mounted in the opening of said holder and electrically connected to said electronic control unit;
a fluid intake control device mounted in a bottom side of said fluid container and set between an open status and a close status to control delivery of a fluid from said fluid storage chamber to said oscillation chamber;
a dip tube set in said fluid container in communication between said fluid storage chamber and said oscillation chamber; and
an outer housing surrounding said fluid container and abutted against said base panel, said outer housing having an opening in air communication between said exhaust passage and the atmosphere.

2. The aromatic nebulizing diffuser as claimed in claim 1, wherein the opening of said outer housing is a narrow, elongated rectangular opening, and said container body of said fluid container has a narrow, elongated rectangular top opening matching the narrow, elongated rectangular opening of said outer housing for producing a curtain of fine mist of aromatic fluid droplets during operation of the aromatic nebulizing diffuser.

3. The aromatic nebulizing diffuser as claimed in claim 1, wherein said dip tube is mounted in said fluid storage chamber of said fluid container and said oscillation chamber and secured in place by a gasket ring; said ultrasonic oscillator has a water seal ring mounted thereon and secured to the center opening of transverse partition board of said holder.

4. The aromatic nebulizing diffuser as claimed in claim 1, further comprising a speaker mounted on said base panel and electrically connected to said electronic control unit; said electronic control unit comprises a control circuit board, a power jack and a sound-source jack, said power jack being mounted on mounted on said base panel and electrically connected to said electronic control unit, said sound-source jack being mounted on said base panel and electrically connected to said electronic control unit for the connection of a sound source cable to transmit an audio signal from an external sound source to said control circuit board for output through said speaker.

5. The aromatic nebulizing diffuser as claimed in claim 1, wherein said outer housing, said holder and said container body are light transmissive.

6. The aromatic nebulizing diffuser as claimed in claim 1, wherein said container base of said fluid container has an upwardly extending connection tube, which is disposed at a relatively higher elevation and connected to said exhaust passage, and a downwardly extending fluid intake port, which is disposed at a relatively lower elevation for the intake of an aromatic fluid.

7. The aromatic nebulizing diffuser as claimed in claim 1, wherein said ultrasonic oscillator has a water level sensor and at least one light emitting device arranged on a top side thereof.

8. The aromatic nebulizing diffuser as claimed in claim 1, wherein said fluid intake control device comprises a first casing, a second casing, a spring member and a ball, said first casing being connected to the downwardly extending fluid intake port of said container base of said fluid container, said second casing being fastened to a bottom side of said first casing, said first casing having an inside annular flange, said second casing having a ball hole disposed in communication with said oscillation chamber, said spring member being mounted in said first casing and said second casing and stopped at a bottom side of said inside annular flange to hold down said ball on said ball hole.

9. The aromatic nebulizing diffuser as claimed in claim 8, wherein said holder has a protruding portion upwardly extended from said transverse partition board and suspending in said oscillation chamber for insertion into said ball hole of said second casing of said fluid intake control device to move said ball upwardly away from said ball hole against said spring member and to further open the passage between said fluid storage chamber and said oscillation chamber.

10. The aromatic nebulizing diffuser as claimed in claim 1, wherein said oscillation chamber has a volume smaller than said fluid storage chamber.
